(19) United States
(12) Patent Application Publication
(10) Pub. No.: US 2016/0095436 A1
(43) Pub. Date: Apr. 7, 2016

(54) A CORNER CADDY

(71) Applicant: 3M INNOVATIVE PROPERTIES COMPANY, St Paul, MN (US)

(72) Inventors: Mark W. Baldwin, Woodbury, MN (US); Roberto Manzari, Milano (IT); Thomas C. Meier, Woodbury, MN (US); Antonio Pugliese, Pomigliano D'Arco (IT); Kayo M. Roehm, Shoreview, MN (US); Lorenzo Ruggieri, Milano (IT); Caroline A. Sazama, Eden Prairie, MN (US); Cynthia A. Timmerman, Hudson, WI (US); Valentina Tronconi, Milano (IT)

(21) Appl. No.: 14/787,779

(22) PCT Filed: Jun. 23, 2014
(86) PCT No.: PCT/US2014/043637

§ 371 Date: Oct. 29, 2015

Related U.S. Application Data
(60) Provisional application No. 61/841,003, filed on Jun. 28, 2013.

(51) Int. Cl. A47B 95/00; F16B 47/00; A47B 96/02; F16B 11/00

(52) U.S. Cl. CPC A47B 95/008; F16B 11/006; F16B 47/00; A47B 96/024

(57) ABSTRACT

The disclosed corner caddy can hold an item in the corner body, but also includes a corner region that is substantially open and free of the caddy body that is useful for hanging or holding large or long items efficiently. In one embodiment, the corner caddy comprises a caddy body, a first attachment wall, a second attachment wall, and a corner region. The base comprises a first end, a second end, a front surface, and a rear surface. The first attachment wall is adjacent the first end and external to the caddy body, and defines a first plane. The second attachment wall is adjacent the second end and external to the caddy body, and defines a second plane. The first plane and second plane intersect to form a corner region, which is adjacent the rear surface and is substantially open and free of the caddy body.

### BACKGROUND

Disclosed is a caddy for connection to a corner. In particular, the corner caddy comprises an caddy body, attachment walls, and a corner region that is substantially open and free of the caddy body.

Caddy devices are used to hold many things such as, for example, soap, kitchen utensils, and cleaning tools. Commonly, caddy devices attach to a single wall, such as shown in U.S. Design Patents 532,234; 532,236; and 416,421. To keep the caddy out of the working environment, it may be desirable to place the caddy in a corner of a wall or device, like a sink or shower. Therefore, corner caddies have been developed for placement into a corner, such as shown in U.S. Pat. No. 5,357,954. However, when wanting to store larger or longer items there is no place to hang or hold other than adjacent the external surface, which undesirably extends into the working environment.

### SUMMARY

The disclosed corner caddy can hold an item in the corner body, but also includes a corner region that is substantially open and free of the caddy body that is useful for hanging or holding large or long items efficiently. In one embodiment, the corner caddy comprises a caddy body, a first attachment wall, a second attachment wall and a corner region. The base comprises a first end, a second end, a front surface, and a rear surface. The first attachment wall is adjacent the first end and external to the caddy body, and defines a first plane. The second attachment wall is adjacent the second end and external to the caddy body, and defines a second plane. The first plane and second plane intersect to form a corner region, which is adjacent the rear surface and is substantially open and free of the caddy body.

In one embodiment, the caddy body is elongated and generally rectangular. In one embodiment, the caddy body is open at a top for receiving an item into the caddy body. In one embodiment, the first attachment wall further comprises a first attachment device and the second attachment wall further comprises a second attachment device. In one embodiment, the first attachment device and second attachment device comprise adhesive, tape, stretch releasing tape, suction fasteners, or mechanical fasteners. In one embodiment, the first plane and the second plane intersect to form an angle between 80 and 100 degrees at the corner region. In one embodiment, the first plane and the second plane intersect to form an angle 90 degrees at the corner region. In one embodiment, the corner caddy further comprises shoulders extending from the rear surface. In one embodiment, the first attachment devices secures to a first wall and the second attachment device secures to a second wall.

In one embodiment, a corner caddy comprises a caddy body, a first attachment wall, a second attachment wall, and corner region. The caddy body comprises a base, a first end, a second end, a front surface, and a rear surface. The first attachment wall, comprising a first attachment mechanism, is adjacent the first end and external to the caddy body, and defines a first plane. The second attachment wall, comprising a second attachment mechanism, is adjacent the second end and external to the caddy body, and defines a second plane. The first plane and the second plane intersect to form an angle between 80 and 100 degrees and to form a corner region, which is adjacent the rear surface and is substantially open and free of the caddy body.

### BRIEF DESCRIPTION OF THE DRAWINGS

FIG. 1 is a perspective view of one embodiment of a corner caddy;

FIG. 2 is a top view of the corner caddy of FIG. 1;

FIG. 3 is a perspective view of one embodiment of a corner caddy secured to a wall;

FIG. 4 is a top view of the corner caddy of FIG. 3 secured to a wall.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

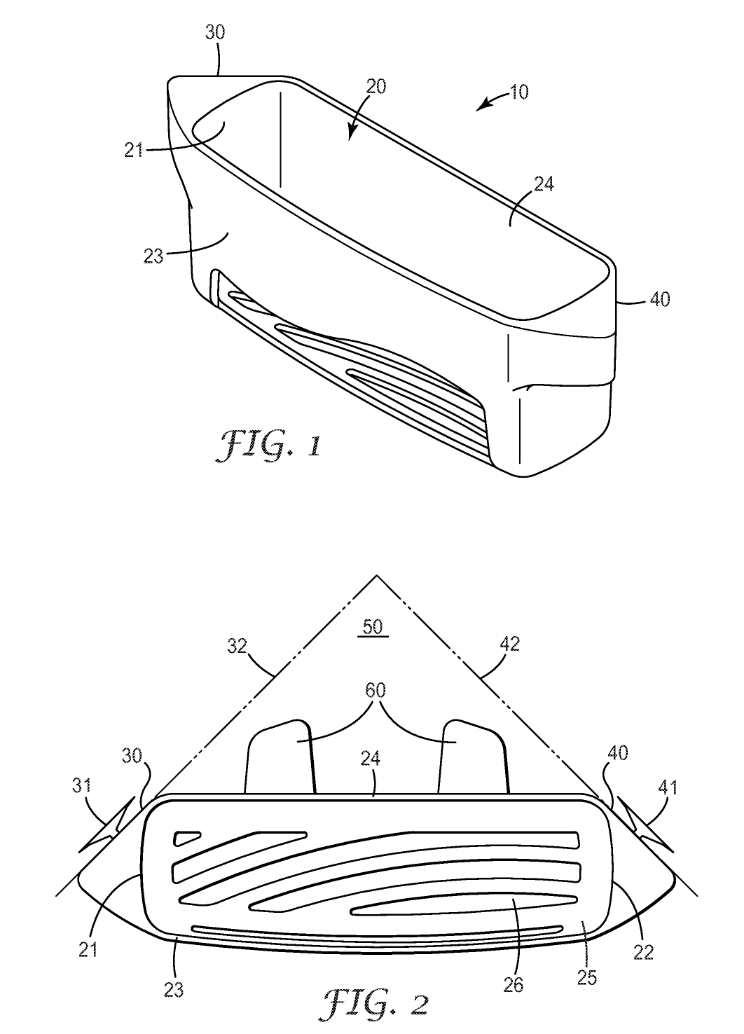

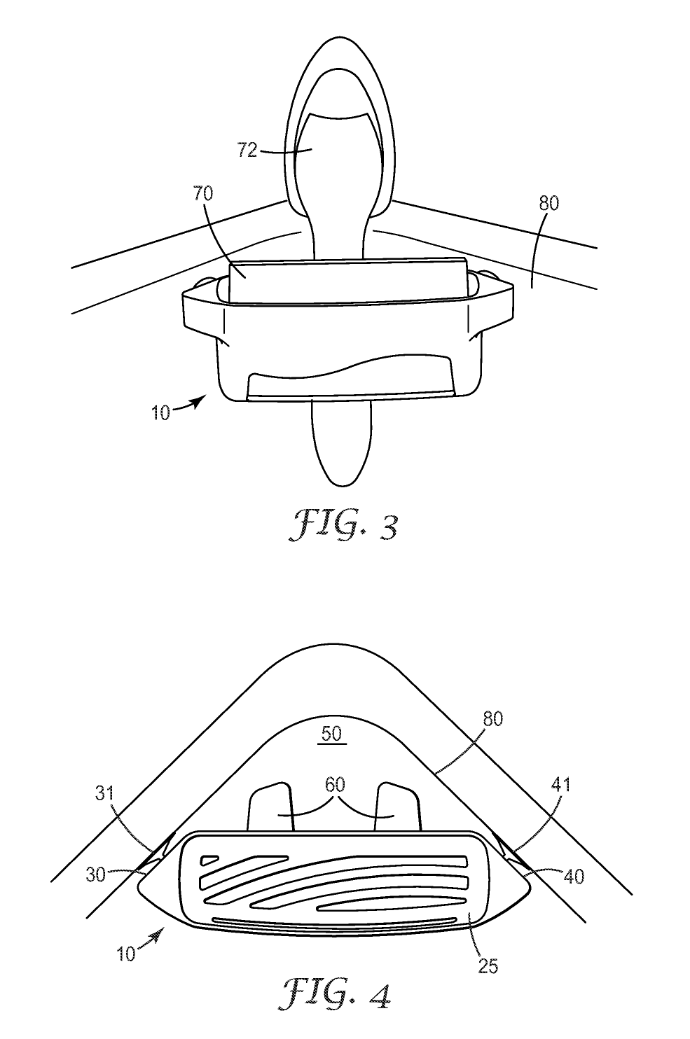

FIG. 1 is a perspective view of one embodiment of a corner caddy 10 and FIG. 2 is a top view of the corner caddy 10 of FIG. 1. FIG. 3 is a perspective view of the corner caddy 10 in use and secured to a wall 80 and FIG. 4 is a top view of the corner caddy 10 shown in FIG. 3.

The corner caddy 10 comprises a caddy body 20, a first attachment wall 30, a second attachment wall 40, and a corner region 50. As best seen in FIGS. 3-4, the caddy body 20 will hold and store item(s) 70. The corner region 50 is substantially open and free of the caddy body 10. In one embodiment, the corner region 50 can be used to store a hanging device 72.

The caddy body 20 can hold an item 70 for storage. The caddy body 20 includes a first end 21, second end 22, front surface 23, a rear surface 24, and a base 25. In one embodiment, such as shown in FIGS. 1-4, the caddy body 20 is open at a top for easily receiving an item 70 into the caddy body 20. Any or all of the first end 21, second end 22, front surface 23, and rear surface 24, or base 25 may include openings 26 for allowing air and fluid to easily pass from the caddy body 20. For example, in some embodiments, the item 70 stored in the caddy body 20 may be wet, like a cloth, a sponge, a scouring pad, awoven, knitted, or nonwoven fabric, and the openings 26 can allow for better drying and removal of dirty fluid contained within the item 70.

The caddy body 20 can be formed in any number of sizes or shapes to allow for storage of an item 70. For example, the caddy body 20 may be square, rectangular, round, cylindrical, cone, or irregular shaped. In one embodiment, such as shown in FIGS. 1-4, the caddy body 20 is elongated such that it is longer than it is wide.

A first attachment wall 30, which can hold a first attachment mechanism 31, is adjacent the first end 21 of the caddy body 20 but external to the caddy body 20. The first attachment wall 30 and the first attachment mechanism 31 will extend in a generally planar direction along a first plane 32. The first attachment mechanism 31 secures to the wall 80 for holding the corner caddy 10 in a corner.

A second attachment wall 40, which can hold a second attachment mechanism 41, is adjacent the second end 22 of the caddy body 20 but external to the caddy body 20. The second attachment wall 40 and the second attachment mechanism 41 will extend in a generally planar direction along a second plane 42. The second attachment mechanism 41 secures to the wall 80 for holding the corner caddy 10 in a corner.

The first plane 32 and second plane 42 intersect. Generally the intersection of the first plane 32 and second plane 42 is approximately at the corner of the wall 80 to which the corner caddy 10 is secured. Generally the corner of the wall 80 forms a 90 degree angle. Therefore, in one embodiment, at the intersection of the first plan 32 and second plane 42, an approximately 90 degree angle is formed. In one embodiment, at the intersection of the first plan 32 and second plane 42, an angle between 80 and 100 degrees is formed. As can be seen best in FIG. 2, the first attachment wall 30 and second attachment wall 40 are symmetrical or mirror images of one another. Therefore, this design will symmetrically fit into the corner of a wall 80 that has an approximately 90 degree angle. It is understood that the corner caddy may be designed to have an asymmetrical fit or to fit an asymmetrical wall such that the planes 32, 42 intersect but not at a 90 degree angle.

The first attachment mechanism 31 and second attachment mechanism 41 typically will be of the same material. However, it is understood that first attachment mechanism 31 can be different from the second attachment mechanism 41. Any known permanent or repositionable attachment mechanism can be used for securing the corner caddy 10 to a wall 80. In one embodiment, the first and the second attachment mechanisms 31, 41 may be adhesive or mechanical fasteners. An adhesive fastener may be, for example, adhesive, a tape, or a stretch releasable adhesive or tape. A mechanical fastener may be, for example, hardware or suction fasteners.

A corner region 50 is formed at the intersection of the first plane 32 and the second plane 42 and is adjacent the rear surface 24 of the caddy body 20. The corner region 50 is substantially open and free of the caddy body 20. Therefore, in use when the corner caddy 10 is secured to a wall 80, such as shown in FIG. 4, the corner region 50 is open. The opening formed by the corner region 50 can provide a place for a large or long item to be placed or stored. For example, such as shown in FIGS. 3 and 4, a hanging item 72 can be suspended from the corner caddy 10 with a portion of the hanging item 72 passing into the corner region 50.

In one embodiment, shoulders 60 extend from the rear surface 24. The shoulders 60 provide a resting surface for a hanging item 72, while a portion of the hanging item 72 can pass into the corner region 50. For example, in one embodiment, the hanging item 72 is a cleaning tool, a cleaning brush, scouring pad, or a dishwand. It is understood that in other embodiments alternative structures may be provided to enable a device to hang through the corner region 50. For example, in one embodiment at the rear surface 24 there may be a hook or planar support. Regardless, the shoulders 60, or other device provided for support, do not extend entirely into the corner region 50. The corner region 50 remains open and free of the caddy body 20.

To use the corner caddy 10, the first attachment mechanism 31 and the second attachment mechanism 41 are secured to a wall 80, which in the embodiment shown in FIGS. 3 and 4 is a wall 80 at a substantially 90 degree angle. An item 70 can be stored in the caddy body 20. A hanging item 72 can be placed into the corner region 50. In the embodiment shown in FIGS. 3 and 4, the shoulders 60 support a portion of the hanging item 72, while another portion of the hanging item 72 passes through the corner region 50.

The corner caddy 10 can be used to store any number of items 70 and hanging items 72. Items 70 that can be stored in the caddy body 20 include, for example, soap, cleaning cloth, scouring pads, and sponges. Hanging items 72 that can be stored at the corner region 50 include, for example, cleaning tools, brushes, scouring pads, and dishwands. The corner caddy 10 can be placed in a number of locations, such as, for example, in a kitchen or bathroom sink, a tub, a shower, a cabinet, or at the intersection of two walls.

Although specific embodiments of this invention have been shown and described herein, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

1. A corner caddy comprising:
a caddy body with a base, a first end, a second end, a front surface, and a rear surface;
a first attachment wall adjacent the first end and external to the caddy body, and defining a first plane; and
a second attachment wall adjacent the second end and external to the caddy body, and defining a second plane;
wherein the first plane and second plane intersect to form a corner region, which is adjacent the rear surface and is substantially open and free of the caddy body.

2. The corner caddy of claim 1, wherein the caddy body is elongated and generally rectangular.

3. The corner caddy of claim 1, wherein the caddy body is open at a top for receiving an item into the caddy body.

4. The corner caddy of claim 1, wherein the first attachment wall further comprises a first attachment device and the second attachment wall further comprises a second attachment device.

5. The corner caddy of claim 1, wherein the first attachment device and the second attachment device comprise adhesive, tape, stretch releasing tape, suction fasteners, or mechanical fasteners.

6. The corner caddy of claim 1, wherein the first plane and second plane intersect to form an angle of between 80 and 100 degrees at the corner region.

7. The corner caddy of claim 1, wherein the first plane and second plane intersect to form an angle of 90 degrees at the corner region.

8. The corner caddy of claim 1, further comprising shoulders extending from the rear surface.

9. The corner caddy of claim 1, wherein the first attachment devices secures to a first wall and the second attachment device secures to a second wall.

10. A corner caddy comprising:
a caddy body with a base, a first end, a second end, a front surface, and rear surface;
a first attachment wall adjacent the first end and external to the caddy body, and defining a first plane, wherein the first attachment wall further comprises a first attachment mechanism; and
a second attachment wall adjacent the second end and external to the caddy body, and defining a second plane, wherein the second attachment wall further comprises a second attachment mechanism;
wherein the first plane and second plane intersect to form an angle of between 80 and 100 degrees to form a corner region, which is adjacent the rear surface and is substantially open and free of the caddy body.
